(19) United States
(12) Patent Application Publication
(10) Pub. No.: US 2017/0094134 A1
(43) Pub. Date: Mar. 30, 2017

(54) Electrical Devices with Camera Sensors

(71) Applicant: COOPER TECHNOLOGIES COMPANY, HOUSTON, TX (US)

(72) Inventors: Michael Alan Lunn, Peachtree City, GA (US); Brian Eugene Elwell, Tyrone, GA (US)

(73) Assignee: COOPER TECHNOLOGIES COMPANY, HOUSTON, TX (US)

(21) Appl. No.: 15/281,636

(22) Filed: Sep. 30, 2016

Related U.S. Application Data
(60) Provisional application No. 62/234,990, filed on Sep. 30, 2015.

(51) Int. Cl. H04N 5/225; H04L 12/28; H04N 7/18

(52) U.S. Cl. CPC H04N 5/2252; H04N 7/18; H04L 12/282

(57) ABSTRACT

An electrical device located in a space. The electrical device can include a functional component for delivering an output. The electrical device can also include a camera sensor that captures at least one sensory element, where the at least one sensory element indicates at least one condition within the space. The electrical device can further include a controller coupled to the functional component and the camera sensor, where the controller controls the functional component based on the at least one sensory element captured by the camera sensor.

### CROSS-REFERENCE TO RELATED APPLICATIONS

This application claims priority under 35 U.S.C. §119 to U.S. Provisional Patent Application Ser. No. 62/234,990, titled “Electrical Devices With Camera Sensors” and filed on Sep. 30, 2015, the entire contents of which are hereby incorporated herein by reference.

### TECHNICAL FIELD

Embodiments described herein relate generally to electrical devices, and more particularly to systems, methods, and devices for light fixtures and other electrical devices with cameras used for sensing functions.

### BACKGROUND

One or more sensors (e.g., infrared detector, photo sensor, occupancy sensor) are often used with electrical devices (e.g., light fixtures) to help those electrical devices or other electrical devices within a system function efficiently. The size of the sensors can become aesthetically unpleasing. When multiple sensors are involved, the various sensors can be combined into a single sensor device, which can also become large enough to be aesthetically unpleasing.

Cameras are becoming increasing popular for security monitoring and related security systems. Many camera used today are aesthetically unpleasing, whether as a stand-alone device or integrated with a device. As technology advances, cameras are becoming less obtrusive.

### SUMMARY

In general, in one aspect, the disclosure relates to an electrical device located in a space. The electrical device can include a functional component for delivering an output. The electrical device can also include a camera sensor that captures at least one sensory element, where the at least one sensory element indicates at least one condition within the space. The electrical device can further include a controller coupled to the functional component and the camera sensor, where the controller controls the functional component based on the at least one sensory element captured by the camera sensor.

In another aspect, the disclosure can generally relate to a controller. The controller can include a hardware processor, and memory having a number of software instructions, where the software instructions are executed by the hardware processor. The controller can also include a transceiver configured to communicate with a camera sensor. The controller can further include a control engine coupled to the transceiver and the hardware processor. The control engine of the controller can be configured to receive a plurality of sensory elements captured by the camera sensor. The control engine of the controller can also be configured to determine a condition based on the plurality of sensory elements. The control engine of the controller can further be configured to control at least one electrical device in response to the condition.

In yet another aspect, the disclosure can generally relate to a system. The system can include a first electrical device located in a space. The system can also include a first camera sensor that captures a plurality of sensory elements in the space proximate to the first electrical device. The system can further include a controller coupled to the first electrical device and the first camera sensor. The controller can receive the sensory elements captured by the first camera sensor. The controller can also determine a condition based on the sensory elements. The controller further also control the first electrical device in response to the condition.

These and other aspects, objects, features, and embodiments will be apparent from the following description and the appended claims.

### BRIEF DESCRIPTION OF THE DRAWINGS

The drawings illustrate only example embodiments of electrical devices with camera sensors and are therefore not to be considered limiting of its scope, as electrical devices with camera sensors may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A-1C show an electrical device that includes a sensor device currently known in the art.

FIGS. 2A and 2B show an electrical device that includes a camera sensor in accordance with certain example.

FIG. 3 shows a system diagram that includes electrical devices with camera sensors in accordance with certain example embodiments.

FIG. 4 shows a system diagram that includes a controller for use with camera sensors in accordance with certain example embodiments.

FIG. 5 shows a computing device in accordance with one or more example embodiments.

FIG. 6 shows a system diagram or another system that includes electrical devices in accordance with certain example embodiments.

### DETAILED DESCRIPTION OF EXAMPLE EMBODIMENTS

The example embodiments discussed herein are directed to systems, apparatuses, and methods of electrical devices with camera sensors. An electrical device described herein can be any type of device that can use and/or be in communication with one or more sensors. Examples of an electrical device can include, but are not limited to, as light fixture, a thermostat, a wall switch, a heating, ventilation, and air conditioning (HVAC) system, an electrical receptacle, a fire control panel, and a shade control device. Example embodiments can be used in any of a number of applications and/or environments.

As described herein, a user can be any person that interacts with electrical devices. Examples of a user may include, but are not limited to, a consumer, an electrician, an engineer, a utility, an electric distribution company, an electrical transmission operator, an instrumentation and control technician, a consultant, a contractor, an operator, and a manufacturer's representative. For any figure shown and described herein, one or more of the components may be omitted, added, repeated, and/or substituted. Accordingly, embodiments shown in a particular figure should not be considered limited to the specific arrangements of components shown in such figure.

Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three digit number and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments can be used in one or more of any of a number of environments. Examples of such environments can include, but are not limited to, indoor, outdoor, office space, manufacturing, hazardous marine, humid, corrosive, high temperature, low temperature, parking lot, and dust. Further, if an example camera sensor is integrated with a light fixture, then the light fixture can be any of a number of types of light fixtures, including but not limited to a floodlight, a recessed light, an emergency egress light, an exit sign, a hi-bay light, an overhead light, a night light, a security light, and a street light.

In certain example embodiments, the electrical devices (or portions thereof) described herein meet one or more of a number of standards, codes, regulations, and/or other requirements established and maintained by one or more entities. Examples of such entities include, but are not limited to, Underwriters' Laboratories (UL), the Institute of Electrical and Electronics Engineers (IEEE), International Electrotechnical Commission (IEC) and the National Fire Protection Association (NFPA). For example, wiring (the wire itself and/or the installation of such wire) that electrically couples to an electrical device may fall within one or more standards set forth in the National Electric Code (NEC). In such a case, the NEC defines Class 1 circuits and Class 2 circuits under various Articles, depending on the application of use.

Example embodiments of electrical devices with camera sensors will be described more fully hereinafter with reference to the accompanying drawings, in which example embodiments of electrical devices with camera sensors are shown. Electrical devices with camera sensors may, however, be embodied m many different forms and should not be construed as limited to the example embodiments set forth herein. Rather, these example embodiments are provided so that this disclosure will be thorough and complete, and will fully convey the scope of electrical devices with camera sensors to those of ordinary skill in the art. Like, but not necessarily the same, elements (also sometimes called components) in the various figures are denoted by like reference numerals for consistency.

Terms such as “first”, “second”, “top”, “bottom”, “side”, “inner”, “outer”, “proximal”, and “distal” are used merely to distinguish one component (or part of a component or state of a component) from another. Such terms are not meant to denote a reference or a particular orientation, and are not meant to limit embodiments of electrical devices with camera sensors. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

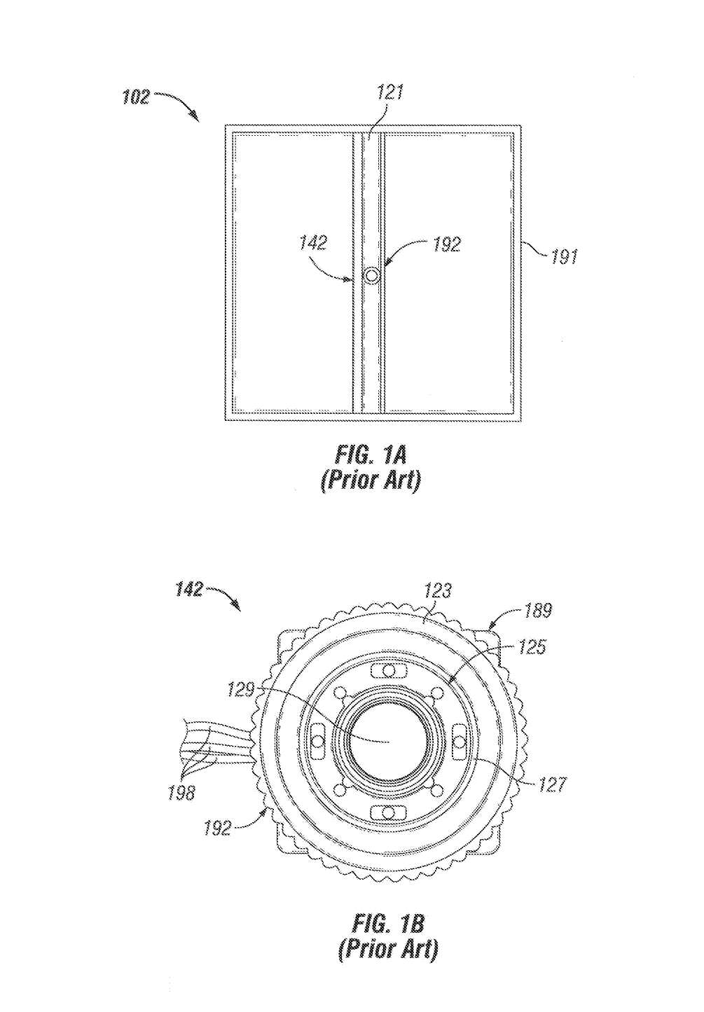

FIGS. 1A-1C show an electrical device 102 that includes a sensor device 142 currently known in the art. Specifically, FIG. 1A shows a top view of the electrical device 102. FIG. 1B shows a top view of the sensor device 142. FIG. 1C shows a top view of a circuit board assembly 119 of the sensor device 142. Referring to FIGS. 1A-1C, the electrical device 102 is a light fixture that has a frame 191 and a center panel 121 on which the sensor device 142 is disposed. The sensor device 142 has a distal assembly 192 that is visible to a user. As FIG. 1A shows, the footprint of the distal assembly 192 is large and noticeable relative to the size of the rest of the electrical device 102.

The circuit board assembly 119 is disposed within the housing 189 of the sensor device 142. The circuit board assembly 119 can include circuit board 110 on which are disposed one or more of a number of components. Examples of such components can include, but are not limited to, a resistor, a capacitor, an integrated circuit, a photo sensor 111, an infrared detector 112, an occupancy sensor 173, and a light-emitting diode (LED) 113. For purposes of this application, each of the components that emit an output (e.g., the LED 113) can be called an output element.

The housing 189 of the sensor device 142 is disposed adjacent to the distal assembly 192 of the sensor device 142. The distal assembly 192 includes an inner body 127, a semi-transparent cover 125, and a trim 123 that is movably (e.g., threadably) coupled to the inner body 127. The trim 123 can be used to hold one or more components of the sensor device 142 in place. For example, the trim 123 can be used to retain the semi-transparent cover 125. The semi-transparent cover 125 can include a number of channels that are aligned with an output element (e.g., photo sensor 111, infrared detector 112, occupancy sensor 173, LED 113) disposed on the circuit board 110.

When the sensor device 142 is disposed within an aperture in the center panel 121 (or some other part of the electrical device 102), the distal assembly 192 is visible to a user, while the remainder of the sensor device 142 (e.g., the housing 189) is not visible to a user. As mentioned above, the footprint of the sensor device 142 is large and protruding. In addition, the number of features of the sensor device 142 that are visible to a user is high. Consequently, sensor devices currently used in the art, such as sensor device 142, lack in aesthetic appeal. The sensor device 142 can include an electrical connector end (not shown) that is configured to couple to a complementary electrical connector end of an electrical device. One or more electrical conductors 198 can be used to electrically couple the components of the circuit board assembly 119 to the electrical connector end of the sensor device 142. The occupancy sensor housing 129 (e.g., a receiver) of the distal assembly 192 is disposed within an aperture that traverses the center of the semi-transparent cover 125.

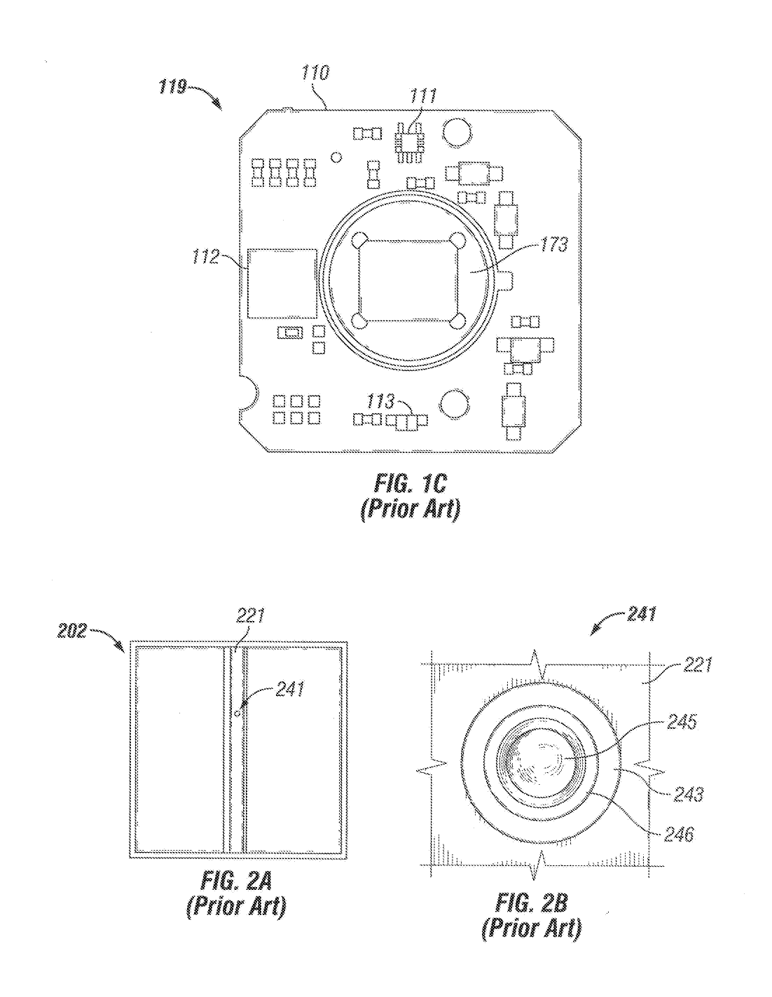

FIGS. 2A and 2B show an electrical device 202 that includes a camera sensor 241 in accordance with certain example. Specifically, FIG. 2A shows a top view of the electrical device 202. FIG. 2B shows a top view of the camera sensor 241. Referring to FIGS. 1A-2B, the electrical device 202 is a light fixture that is substantially similar to the electrical device 102 of FIG. 1A, except that the sensor device 142 of FIGS. 1A-1C is replaced by the camera sensor 241. In certain example embodiments, the camera sensor 241 has a substantially smaller profile than the sensor devices (e.g., sensor device 142) currently used in the art. As a result, the electrical device having the camera sensor 241 is more aesthetically pleasing, and the camera sensor 241 has a smaller footprint and is less visible to a user compared to the sensor device 142 currently used in the art.

The camera sensor 241 can have one or more of a number of different components and/or appearances. For example, as shown in FIG. 2B, a camera sensor 241 can have a lens 245, a body 246 and a bezel 243 that secures the lens 245 against the body 243. By using the camera sensor 241 to measure one or more of the parameters traditionally measured by a sensor device (e.g., sensor device 142), an electrical device can have a sensor device with greatly reduced size or, in some cases, no sensor device at all.

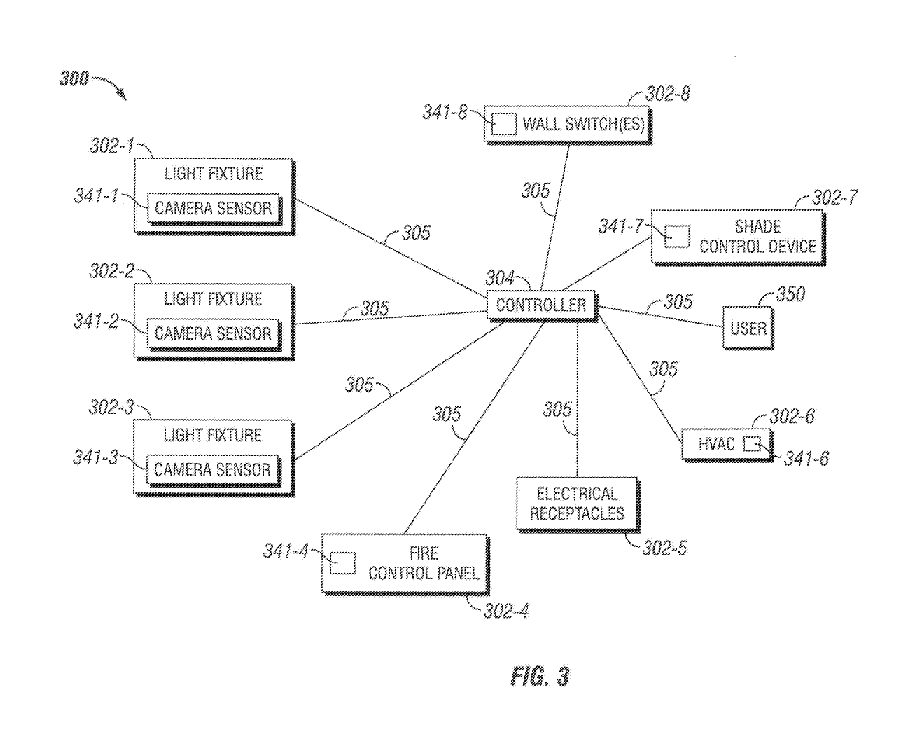

FIG. 3 shows a diagram of a system 300 that includes electrical devices 302 with camera sensors 341 in accordance with certain example embodiments. Referring to FIGS. 1A-3, the system 300 of FIG. 3 includes a central controller 304, a total of eight electrical devices 302, which include one or more wall switches (electrical device 302-8), one or more electrical receptacles (also more simply called receptacles) (electrical device 302-5), a HVAC unit (which can include a thermostat or other control device) (electrical device 302-6), a fire control panel (electrical device 3802-4), a shade control device (electrical device 302-7), and three light fixtures (e.g., electrical device 302-1, electrical device 302-2, electrical device 302-3)), and a user 350. There can be one or more of a number of other devices 302 in the system 300, including but not limited to a demand response component and an alarm device.

One or more of the electrical devices 302 can include a camera sensor 342. For example, in this case, camera sensor 341-1 is part of electrical device 302-1, camera sensor 341-2 is part of electrical device 302-2, camera sensor 341-3 is part of electrical device 302-3, camera sensor 341-4 is part of the electrical device 302-4, camera sensor 341-6 is part of the electrical device 302-6, camera sensor 341-7 is part of the electrical device 302-7, and camera sensor 341-8 is part of at least one of the electrical devices 302-8. The user 350 of the system 300 can be substantially similar to the user defined above.

In certain example embodiments, the controller 304 is connected (in this case directly) to each of the other components in the system 300 (the various electrical devices 302, including any corresponding camera sensors 341, and the user 350) using communication links 305. In some cases, the controller 304 can be called by other names, such as a coordinator in the context of ZigBee-based communication protocols. Each communication link 305 can include wired (e.g., Class 1 electrical cables, Class 2 electrical cables, electrical connectors) and/or wireless (e.g., Wi-Fi, visible light communication, cellular networking, ZigBee, Bluetooth, WirelessHART ISA100, Power Line Carrier, RS485, DALI) technology. For example, a communication link 305 can be (or include) one or more electrical conductors that are coupled to electrical device 302-2. A communication link 305 can transmit signals (e.g., communication signals, control signals, power signals, data) between the controller 304 and the user 350 and the other devices of the system 300.

With the configuration shown in FIG. 3, each of the electrical devices (e.g., electrical device 302-1, electrical device 302-2, electrical device 302-3, electrical device 302-8) has no control capabilities, as these capabilities reside with the controller 304. Further, the electrical devices 302 shown in FIG. 3 may not be able to communicate directly with other electrical devices 302 in the system 300. In such a case, the controller 304 controls all communication with the electrical devices 302 in the system 300.

While all three of the light fixtures, the fire control panel, the HVAC system, the shade control device, and one or more of the wall switches of FIG. 3 are shown to have their own camera sensor 341, one or more other electrical devices 302 (e.g., one or more of the electrical receptacles) of the system 300 that are currently not shown as having their own camera sensor 341 can be altered to include their own camera sensor 341. Conversely, fewer camera sensors 341 can be used in the system 300. In other words, one or more of the electrical devices 302 shown in FIG. 3 as having its own camera sensor 341 can be without a camera sensor 341.

If an electrical device 302 does not have its own camera sensor 341, then that electrical device 302 can be controlled by the controller 304 using information provided to the controller 304 by a camera sensor 341 of one or more other electrical devices 302 in the system 300. In addition, or in the alternative, rather than solely relying on one controller 304 in the system, one or more of the electrical devices 302 in the system 300 can have its own local controller that performs some or all of the functions of the controller 304. In addition, or in the alternative, one or more of the electrical devices 302 can be directly coupled to one or more other electrical devices 302 in the system 300 using the communication links 305.

In addition, or in the alternative, a camera sensor 341 can be a stand-alone device in the system 300. A camera sensor 341 can use digital technology, analog technology, flash technology, dim light technology, auto-focus technology, zoom/pan technology, filtering technology, and/or any other type of technology to capture one or more sensory elements. A camera sensor 341 can include a camera to capture one or more images. The camera can be a movie camera, a still camera, or any other type of camera. In some cases, a camera sensor 341 can include a microphone or other audio device to detect sound. Consequently, a camera sensor 341 can capture, directly or indirectly, images, audio, and/or any other sensory element. In certain example embodiments, a camera sensor 341, whether on its own or in conjunction with another device, can be configured to project images, sounds, and/or other sensory elements in addition to, or in the alternative of, capturing images, sounds, and/or other sensory elements. As defined herein, a camera sensor can include a microphone, a projector, a speaker, and/or any other device or component that can allow the camera sensor to capture and/or project images, sounds, and/or other sensory elements.

Regardless of whether the controller 304 is a central controller, as shown in FIG. 3, and/or if there are one or more local controllers that are part of one or more electrical devices 302 in the system 300, the controller 304 is used to interpret the sensory elements (e.g., images, sound) captured by a camera sensor 341 and convert those sensory elements into parameters that can be read, similar to how a sensor device would measure such parameters. For example, the controller 304 can be used to interpret the images captured by the camera sensor 341 to give the camera sensor 341 sensor capability. In certain example embodiments, the controller 304 can, additionally or alternatively, interpret audio captured by a camera sensor 341 and generate commands based on the interpretation of that audio.

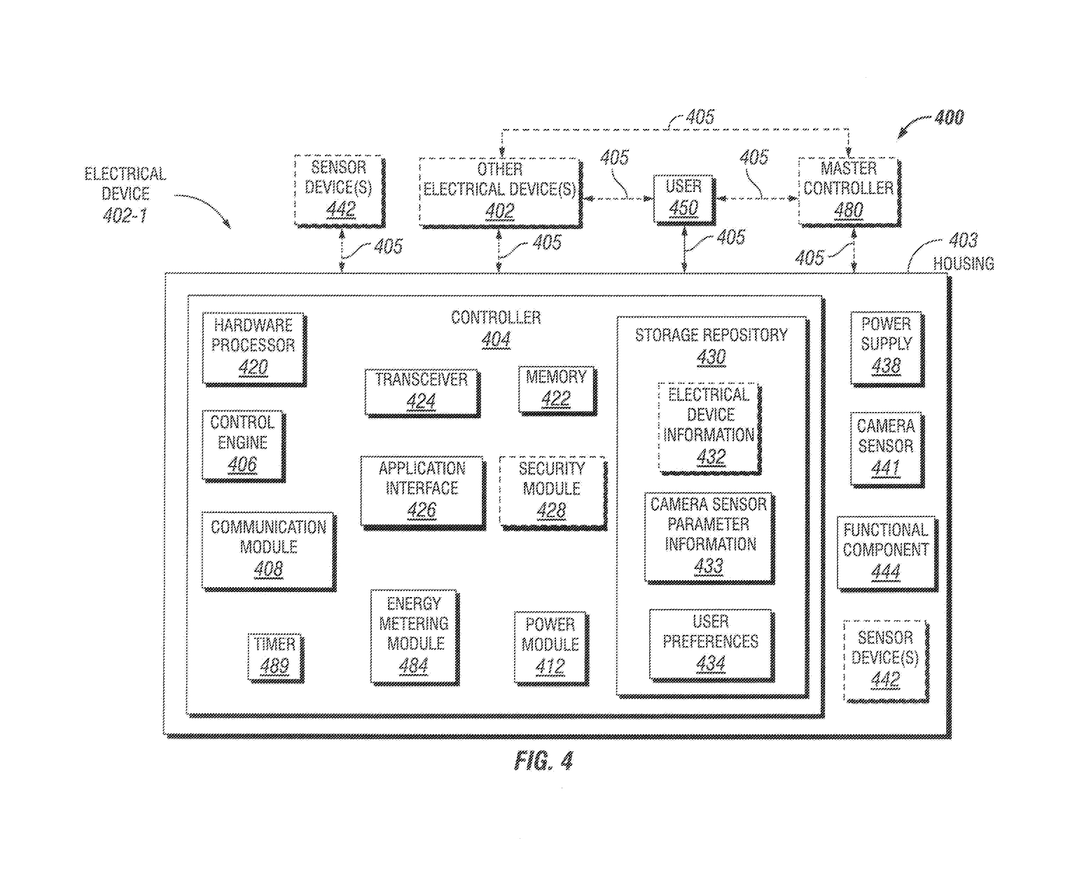

FIG. 4 shows a system diagram that includes a controller 404 for use with camera sensors 441 in accordance with certain example embodiments. In addition to the electrical device 402-1, the system 400 of FIG. 4 can include one or more optional additional electrical devices 402, a user 450, one or more optional other devices 380, and one or more optional sensors 442. The electrical device 402-1 can include a controller 404, a power supply 438, a functional component 444, at least one camera sensor 440, and one or more of the optional sensor devices 442. The controller 404 can include, one or more of a number of components. Such components, can include, but are not limited to, a control engine 406, a communication module 408, a timer 489, a power module 412, an energy metering module 484, a storage repository 430, a hardware processor 420, a memory 422, a transceiver 424, an application interface 426, and, optionally, a security module 428.

The components shown in FIG. 4 are not exhaustive, and in some embodiments, one or more of the components shown in FIG. 4 may not be included in an example electrical device 402-1. Any component of the example electrical device 402-1 can be discrete or combined with one or more other components of the electrical device 402-1. In addition, the location of one or more components can vary from what is shown in FIG. 4. For example, as described above, an electrical device (e.g., electrical device 402-1) may not have a local controller 404, and instead communicate with a controller located in another electrical device and/or a master (central) controller.

The user 450 is the same as a user defined above. The user 450 interacts with (e.g., sends data to, receives data from) the controller 404 of the electrical device 402-1 via the application interface 426 (described below). The user 450 can also interact with one or more master controller 480, one or more sensor devices 442, and/or one or more electrical devices 402. Interaction between the user 450 and the electrical device 402-1, the master controller 480, and the electrical devices 402 can be conducted using communication links 405. The communication links 405 can transmit signals (e.g., communication signals, control signals, data) between the electrical device 402-1 and the user 450, one or more of the master controller 480, one or more sensor devices 442, and/or one or more of the electrical devices 402.

The master controller 480 can be a stand-alone unit. Alternatively, the master controller 480 can be a part of any type of device (e.g., an electrical device 402). Examples of such devices can include, but are not limited to, an electrical receptacle, a HVAC system, a wall switch, a fire control panel, and a shade control device. A master controller 480 can communicate with the user 450 and/or electrical device 402-1 using one or more communication links 405. In such a case, the devices 380 (or system thereof) can use one or more of a number of communication protocols.

An electrical device (electrical device 402-1) can be a single electrical device, or a grouping of electrical devices. Each electrical device can use one or more of a number of communication protocols. As discussed above, an electrical device 402 can be any type of device that uses electricity. Examples of such electrical devices 402 can include, but are not limited to, the master controller 480, a wall switch 301, an electrical receptacle 307, a HVAC unit 309, a shade control device 399, and a light fixture 202.

An electrical device (e.g., electrical device 402-1) and or the master controller 480 can include and/or be coupled to one or more camera sensors 441, such as the camera sensors described above. In some cases, one or more camera sensors 441 can be included with and/or coupled to a master controller 480. These camera sensors 441 can monitor conditions in and/or around the electrical device 402. Examples of such conditions can include, but are not limited to, a level of ambient light, the presence of a person, the identity of a person, identification of smoke before a fire starts, a fire, movement of a person, color tuning, traffic flow within a space, and a comparison of natural and ambient light. As a result, a camera sensor 441, when coupled with the controller 404, can eliminate a number of sensors that are used in the art today. Such sensors can include, but are not limited to, a photocell, an infrared light detector, a thermometer, a smoke detector, a scanner, and an acoustic detector. In certain example embodiments, a camera sensor 441 is integrated with an electrical device 402. Alternatively, a camera sensor 441 is not integrated with an electrical device 402, but is rather a stand-alone device that is communicably coupled with the controller 404.

A camera sensor 441 can receive power, control, and/or communication signals from the power supply 438. The power supply 438 of an electrical device (e.g., electrical device 402-1) can send power, control, and/or communication signals to a camera sensor 440. Examples of a power supply 438 can include, but are not limited to, a driver and a ballast. The power supply 438 can be a source of independent power generation. For example, the power supply 438 can include an energy storage device (e.g., a battery, a supercapacitor). As another example, the power supply 438 can include photovoltaic solar panels. In addition, or in the alternative, the power supply 438 can receive power from an independent power supply. The independent power supply can be any source of power that is independent of the power supply 438. Examples of a power supply can include, but are not limited to, an energy storage device, a feed to a building, a feed from a circuit panel, and an independent generation source (e.g., photovoltaic panels, a heat exchanger).

In certain example embodiments, the power supply 438 sends power, control, and/or communication signals to, and receives power, control, and/or communication signals from, the controller 404 of the electrical device 402-1. In this way, the controller 404 of the electrical device 402-1 controls the power supply 438 (and, thus, the camera sensors 440) of the electrical device 402-1.

The controller 404 of an electrical device (e.g., electrical device 402-1) can interact (e.g., periodically, continually, randomly) with another electrical device 402, a sensor device 442, the user 450, and/or the master controller 480. The user 450, the sensor devices 442, the master controller 480, and/or the electrical devices 402 can interact with the controller 404 of the electrical device 402-1 using the application interface 426 and the communication links 405 in accordance with one or more example embodiments. Specifically, the application interface 426 of the controller 404 receives data (e.g., information, communications, instructions) from and sends data (e.g., information, communications, instructions) to the user 450, the sensor devices 442, the master controller 480, and/or the other electrical devices 402.

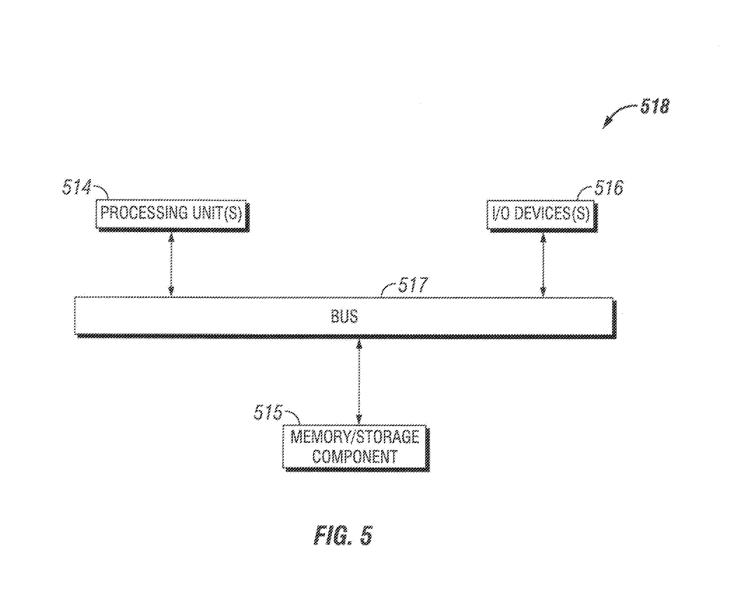

The controller 404, the user 450, the sensor devices 442, the master controller 480, and/or the electrical devices 402 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 404. Examples of such a system can include, but are not limited to, a desktop computer with LAN, WAN, Internet or intranet access, a laptop computer with LAN, WAN, Internet or intranet access, a smart phone, a server, a server farm, an android device (or equivalent), a tablet, smartphones, and is personal digital assistant (PDA). Such a system can correspond to a computer system as described below with regard to FIG. 5.

Further, as discussed above, such a system can have corresponding software (e.g., user software, light fixture, software, controller software, sensor software, device software). The software can execute on the same or a separate device (e.g., a server, mainframe, desktop personal computer (PC), laptop, personal desktop assistant (PDA), television, cable box, satellite box, kiosk, telephone, mobile phone, or other computing devices) and can be coupled by the communication network (e.g., Internet, Intranet, Extranet, Local Area Network (LAN), Wide Area Network (WAN), or other network communication methods) and/or communication channels, with wire and/or wireless segments according to some example embodiments. The software of one system can be a part of, or operate separately but in conjunction with, the software of another system within the system 400.

The electrical device 402-1 can include a housing 403. The housing 403 can include at least one wall that forms a cavity. The housing 403 of the electrical device 402-1 can be used to house, at least in part, one or more components (e.g., the power supply 438, the camera sensor 441, the controller 404, the functional component 444) of the electrical device 402-1, including one or more components of the controller 404. For example, as shown in FIG. 4, the controller 404 (which in this case includes the control engine 406, the communication module 408, the timer 489, the power module 412, the energy metering module 484, the storage repository 430, the hardware processor 420, the memory 422, the transceiver 424, the application interface 426, and the optional security module 428) can be disposed within the cavity formed by the housing 403. In alternative embodiments, any one or more of these or other components of the electrical device 402-1 can be disposed on the housing 403 and/or remotely from the housing 403.

The functional component 444 of the electrical device 402-1 delivers and/or prevents delivery, directly or indirectly, of the output (e.g., light, electrical power, sound, color, shade) for which the electrical device 402 is designed. For example, if the electrical device 402 is a light fixture, the functional component 444 is one or more light sources that emit light. As another example, if the electrical device 402 is a stereo, the functional component 444 can include a speaker (including the associated electronics) through which sound is emitted. As yet another example, if the electrical device 402 is a wall outlet, the functional component 444 can include a switch (e.g., a breaker, a contactor, a relay) that can open or close to prevent or allow power to flow. The functional component 444 can control delivery of more than one output. In some cases, an electrical device 402 can have multiple functional components 444. The functional component 444 of an electrical device 402 can be controlled by the controller 404, where such control can be based, at least in part, on data (e.g., images, sound) captured by the camera sensor 441.

The storage repository 430 can be a persistent storage device (or set of devices) that stores software and data used to assist the controller 404 in communicating with the user 450, one or more sensor devices 442, the master controller 480, and one or more other electrical devices 402 within the system 400. In one or more example embodiments, the storage repository 430 stores optional electrical device information 432, camera sensor parameter information 433, and user preferences 434. The electrical device information 432 can be any information associated with an electrical device, including electrical device 402-1. Such information can include, but is not limited to, manufacturer's information of an electrical device, age of an electrical device, hours of operation of an electrical device, communication protocols of an electrical device, physical location of an electrical device, and orientation of an electrical device.

The camera sensor parameter information 433 can be any sensor parameters that can be interpreted based on the sensory elements (e.g., images, sounds) captured by the camera sensor 441. Such information can include, but is not limited to, formulas and/or algorithms, color capabilities of the camera sensor 441, speed (e.g., frames per second) of the camera sensor 441, physical location of a camera sensor 441, manufacturer of a camera sensor 441, manufacturer's information of a camera sensor 441, age of a camera sensor 441, hours of operation of a camera sensor 441, and communication protocols of a camera sensor 441. The user preferences 334 can be any data associated with the preferences of a particular user 450.

The storage repository 430 can also store other types of data. Examples of such other types of data can include, but are not limited to, measurements taken by the energy metering module 484, threshold values, algorithms, results of previously run or calculated algorithms, and previous communications with other components (e.g., sensor devices 442, other electrical devices 402) in the system 400. Such data can be any type of data, including but not limited to historical data, calculated data, forecasted data, comparison data, and actual data. Any data stored in the storage repository 430 can be associated with some measurement of time derived from, for example, the timer 489.

Examples of a storage repository 430 can include, but are not limited to, a database (or a number of databases), a file system, a hard drive, flash memory, some other form of solid state data storage, or any suitable combination thereof. The storage repository 430 can be located on multiple physical machines, each storing all or a portion of the electrical device information 432, camera sensor parameter information 433, and/or the user preferences 434 according to some example embodiments. Each storage unit or device can be physically located in the same or in a different geographic location.

The storage repository 430 can be operatively connected to the control engine 406. In one or more example embodiments, the control engine 406 includes functionality to communicate with the user 450, the sensor devices 442, the master controller 480, and the other electrical devices 402 in the system 400. More specifically, the control engine 406 sends information to and/or receives information from the storage repository 430 in order to communicate with the user 450, the sensor devices 442, the master controller 480, and the other electrical devices 402. As discussed below, the storage repository 430 can also be operatively connected to the communication module 408 in certain example embodiments.

The controller 404 and its various components (described below) combine discreet camera-based technology with various electrical devices 402 (e.g., light fixtures) to produce traditional sensing capabilities as well as new, more advanced sensing capabilities. Example embodiments can provide automatic grouping of electrical devices for occupancy, vacancy, and daylighting (including a determination of natural light level as opposed to artificial light level) using wired and/or wireless technology. The controller 404 can be used to interpret information based on sensory elements (e.g., images, sounds) supplied by the camera sensor 441. These capabilities of the controller 404 allow for control of one or more electrical devices 402 in the system 400, review of historical actions taken, and predictively analyzing future needs (e.g., maintenance) with respect to components in the system 400.

A non-exclusive list of functions that can be performed by the controller 404 based on sensory elements (e.g., images, sounds) received from a camera sensor 441 can include occupancy/vacancy detection for light level adjustments, vacancy detection fur automatic receptacle control to ensure plug loads are turned off when the space is vacant, daylight detection for light level adjustments, natural versus artificial light comparison for real-time light level tuning, counting the number of people in a space (as well as their location in the space) for security lighting adjustments as well as space utilization analysis, follow people's directional movements for automatic light level control, sensing intelligent visible light communication from user devices for programming and user controls, facial recognition for pre-defined light levels, and intelligent gesture control for light level adjustments.

When the controller 404 utilizes high speed network capabilities (e.g., WIFI 802.11 standard), electrical devices 402 can be grouped and share information derived from sensory elements (e.g., images, sounds) captured by a camera sensor 441. This can allow the controller 404 to have enterprise network control. Utilizing one or more WIFI standards also allows one or more electrical devices 402 to become part of the Internet of Things. For example, the controller 404 and the information it derives from sensory elements captured by the camera sensor 441 can be connected to larger building systems (e.g., master controller 480) for integration of data into such systems as emergency systems (e.g., for traffic flow), HVAC systems, closed-circuit television (CCTV) systems, security systems, and fire protection systems.

Utilizing the controller 404 based on sensory elements captured by the camera sensor 411 allows an electrical device 402 to be a sensing data point in a system (e.g., system 400) that can communicate with other systems using high speed data networks. In such a case, non-exclusive examples of functions that can be performed include people occupancy and counting for HVAC control, connection to a CCTV system at an individual electrical device allowing for greater coverage of CCTV data points, connection to a security system for individual electrical device security coverage in common areas, and connection to a fire protection system for early detection of excessive heat signatures in spaces or visible detection of flame or smoke.

Using data generated by the controller 404 based on sensory elements captured by the camera sensor 411 provides the capability of gathering large amounts of data for analytics and historical data. The data can be analyzed and/or stored by the controller 404 or some other controller (e.g., master controller 480) of a system (e.g., system 400 and/or by a user 450. Further, images captured by the camera sensor 411 can continually monitor the amount of power being used in each electrical device 402 for power data gathering, using, for example, the energy metering module 484. This data can be transmitted by the controller 404 using high speed (wired and/or wireless) data networks (e.g., RS485, WIFI) for any of a number of purposes, including but not limited to storage, predictive and/or historical analysis, and presentation to a user 450.

In certain example embodiments, the control engine 406 of the controller 404 controls the operation of one or more components (e.g., the communication module 408, the timer 489, the transceiver 424) of the controller 404. For example, the control engine 406 can put the communication module 408 in “sleep” mode when there are no communications between the controller 404 and another component (e.g., another electrical device 402, the user 450) in the system 400 or when communications between the controller 404 and another component in the system 400 follow a regular pattern. In such a case, power consumed by the controller 404 is conserved by only enabling the communication module 408 when the communication module 408 is needed.

As another example, the control engine 406 can acquire the current time using the timer 489. The time 489 can enable the controller 404 to control the camera sensor 441 even when the controller 404 has no communication with the external controller (e.g., master controller 480). In certain example embodiments, the timer 489 can track the amount of time that the camera sensor 441 is operating. In such a case, the control engine 406 can control the camera sensor 441 based on an amount of time measured by the timer 489.

The control engine 406 can provide control, communication, and/or other similar signals to the user 450, one or more sensor devices 442, the master controller 480, and one or more of the other electrical devices 402. Similarly, the control engine 406 can receive control, communication, and/or other similar signals from the user 450, one or more sensors 442, the master controller 480, and one or more of the electrical devices 402. The control engine 406 can control the electrical device 402-1 automatically (for example, based on one or more algorithms stored in the electrical device information 432 of the storage repository 430) and/or based on control, communication, and/or other similar signals received from a controller of another component of the system 400 through the communication links 405. The control engine 406 may include a printed circuit board, upon which the hardware processor 420 and/or one or more discrete components of the controller 404 can be positioned.

In certain example embodiments, the control engine 406 can include an interface that enables the control engine 406 to communicate with one or more components (e.g., communication module 408) of the electrical device 402-1 and/or another component (e.g., another light fixture 302) of the system 400. For example, if the power supply 438 for the electrical device 402-1 operates under IEC Standard 62386, then the power supply 438 can include a digital addressable lighting interface (DALI). In such a case, the control engine 406 can also include a DALI to enable communication with the power supply 438 within the electrical device 402-1. Such an interface can operate in conjunction with, or independently of, the communication protocols used to communicate between the controller 404 and the user 450, the master controller 480, the sensor devices 442, and the other electrical devices 402.

The control engine 406 can operate in real time. In other words, the control engine 406 of the controller 404 can process, send, and/or receive communications with the user 450 and/or other controllers (e.g., the master controller 480), other electrical devices 402, and sensor devices 442 as any changes (e.g., discrete, continuous) occur within the system 400. Further, the control engine 406 of the controller 404 can, at substantially the same time, control the electrical device 402-1, a sensor device 442, another electrical device 402, and/or the master controller 480 based on such changes. In addition, the control engine 406 of the controller 404 can perform one or more of its functions continuously. For example, the controller 404 can continuously communicate electrical device information 432, camera sensor parameter information 433, and/or any other information. In such a case, any updates or changes to such information (e.g., footage captured by the camera sensor 441) can be used by the controller 404 in adjusting an output (e.g., current) sent by the power supply 438 to a camera sensor 441.

In certain example embodiments, the control engine 406 of the controller 404 can operate (e.g., in real time) used on demand response signals received from a user (e.g., a utility, a homeowner). Further, the control engine 406 (or other portion of the controller 404) can include a measurement module (not shown) that monitors and captures the power (e.g., current) used by the electrical device 402-1, one or more of the sensor devices 442 the master controller 480, and/or another electrical device 402. In addition, the control engine 406 (or other portion of the controller 404) can include a timer (not shown). In such a case, the timer can measure one or more elements of time, including but not limited to clock time and periods of time. The timer can also include a calendar in addition to clock functions.

In certain example embodiments, the controller 404 receives data (e.g., a live feed, a set of frames) from the camera sensor 441. Using the software stored in memory 422 and the data (e.g., algorithms) stored in the storage repository 430, the control engine 406 identifies objects in the footage captured by the camera sensor 441. These objects, when certain conditions are met, drive the control engine 406 of the controller 404 to control one or more electrical devices 402.

For example, if the footage captured by the camera sensor 441 includes a person, the control engine 406 (using, for example, facial recognition software and related tools) may be able to specifically identify that person. In such a case, that particular person may have preferences with respect to conditions (e.g., temperature, amount of lighting) in a space (e.g., room) when the person is present. For example, if the person that is identified by the control engine 406 prefers the temperature of a room to be 72° F., the control engine 406 of the controller 404 can control the HVAC unit 309 to make the temperature in the room 72° F. As another example, if the person that is identified by the control engine 406 prefers the light in the room to be cool white with a brightness of 75%, the control engine 406 of the controller 404 can control the light fixtures 302 in the room to emit light that is cool white with a brightness of 75%. In such a case, ambient light in the space can be determined and considered by the control engine 406 in order to properly adjust the hue, saturation, and other color characteristics present in the space according to the preferences of the identified person.

As another example of the capability of a control engine 406 of an example controller 404, if the footage captured by the camera sensor 441 shows someone in a hallway, the control engine 406 can identify the person is in the hallway. As a result, as the person moves in the hallway, the control engine 406 of the controller 404 can control the light fixtures 302 in the hallway in such a way that a light fixture 302 is at full brightness when the person is within 15 feet of the light fixture 302 and dim (e.g., to 25%, to 0% (off)), to 50%) when the person is greater than 15 feet from the light fixture. In this way, the control engine 406 of the controller 404 follows the directional flow of movement through its control of the light fixtures 302.

As yet another example of the capability of a control engine 406 of an example controller 404, if the footage captured by the camera sensor 441 shows someone in a room, the control engine 406 can identify that the room is occupied. As a result, the control engine 406 of the controller 404 can control one or more of a number of electrical devices 402 in the room. For example, the control engine 406 can control the light level in the room because of the occupancy of the room. In such a case, the control engine 406 can determine an amount of ambient light in the room using the footage captured by the camera sensor 441 and use the amount of ambient light to determine whether and how to adjust a shade control device 399 and whether and how to adjust the output of the light fixtures 302 in the room. The control engine 406 can also consider other factors (time of day, time of year, current weather conditions) when controlling the light level in the room. In addition, or in the alternative, the control engine 406 of the controller 404 can control one or more of a number of other electrical devices 402 based on determining that a room is occupied. For example, the control engine 406 can deliver power to the electrical receptacles 307 in the room, control the HVAC unit 309 to make the temperature in the room 72° F. and the humidity 60%, and activate the wall switches 301 so that a user 450 can use them to control an electrical device 402.

As yet another example of the capability of a control engine 406 of an example controller 404, if the footage captured by the camera sensor 441 shows smoke, the control engine 406 can identity that a fire is about to start. As a result, the control engine 406 of the controller 404 can control a fire control panel 383 by sounding the audible fire alarm within the building, calling the fire department to alert them of a fire, control the light fixtures 302 to provide people a safe path of egress that avoids the area with the fire, and sets off the sprinkler system in the area of the fire.

The control engine 406 (or other components of the controller 404) can also include one or more hardware and/or software architecture components to perform its functions. Such components can include, but are not limited to, a universal asynchronous receiver/transmitter (UART), a universal synchronous receiver/transmitter (USRT), a serial peripheral interface (SPI), a direct-attached capacity (DAC) storage device, an analog-to-digital converter, an inter-integrated circuit (I²C), and a pulse width modulator (PWM).

In certain example embodiments, the communication module 408 of the controller 404 determines and implements the communication protocol (e.g., from the electrical device information 432 and the camera sensor parameter information 433 of the storage repository 430) that is used when the control engine 406 communicates with (e.g., sends signals to, receives signals from) the user 450, one or more of the sensor devices 442, the master controller 480, and/or one or more of the other electrical devices 402. In some cases, the communication module 408 accesses the electrical device information 432 and/or the camera sensor parameter information 433 to determine which communication protocol is within the capability of the recipient of a communication sent by the control engine 406. In addition, the communication module 408 can interpret the communication protocol of a communication received by the controller 404 so that the control engine 406 can interpret the communication.

The communication module 408 can send data directly to and/or retrieve data directly from the storage repository 430. Alternatively, the control engine 406 can facilitate the transfer of data between the communication module 408 and the storage repository 430. The communication module 408 can also provide encryption to data that is sent by the controller 404 and decryption to data that is received by the controller 404. The communication module 408 can also provide one or more of a number of other services with respect to data sent from and received by the controller 404. Such services can include, but are not limited to, data packet routing information and procedures to follow in the event of data interruption.

The timer 469 of the controller 404 can track clock time, intervals of time, an amount of time, and/or any other measure of time. The time 489 can also count the number of occurrences of an event, whether with or without respect to time. Alternatively, the control engine 406 can perform the counting function. The timer 489 is able to track multiple time measurements concurrently. The timer 489 can track time periods based on an instruction received from the control engine 406, based on an instruction received from the user 450, based on an instruction programmed in the software for the controller 404, based on some other condition or from some other component, or from any combination thereof.

The timer 489 can be configured to track time when there is no power delivered to the controller 404 (e.g., the power module 412 malfunctions) using, for example, a super capacitor or a battery backup. In such a case, when there is a resumption of power delivery to the controller 404, the timer 489 can communicate any aspect of time to the controller 404. In such a case, the timer 489 can include one or more of a number of components (e.g., a super capacitor, an integrated circuit) to perform these functions.

The energy metering module 484 of the controller 404 measures one or more components of power (e.g., current, voltage, resistance, VARs, watts) associated with the electrical device 402 at one or more points in the system 400. The energy metering module 484 can include any of a number of measuring devices and related devices, including but not limited to a voltmeter, an ammeter, a power meter, an ohmmeter, a current transformer, a potential transformer, and electrical wiring. The energy metering module 484 can measure a component of power continuously, periodically, based on the occurrence of an event, based on a command received from the control engine 406, based on sensory elements captured by the camera sensor 441, and/or based on some other factor.

The power module 412 of the controller 404 provides power to one or more other components (e.g., timer 489, control engine 406) of the controller 404. In certain example embodiments, the power module 412 receives power from the power supply 438. The power module 412 can include one or more of a number of single or multiple discrete components (e.g., transistor, diode, resistor), and/or a microprocessor. The power module 412 may include a printed circuit board, upon which the microprocessor and/or one or more discrete components are positioned. In some cases, the power module 412 can include one or more components that allow the power module 412 to measure one or more elements of power (e.g., voltage, current) that is delivered to and/or sent from the power module 412.

The power module 412 can include one or more components (e.g., a transformer, a diode bridge, an inverter, a converter) that receives power (for example, through an electrical cable) from a source (e.g., the power supply 438) and generates power of a type (e.g., alternating current, direct current) and level (e.g., 12V, 24V, 470V) that can be used by the other components of the controller 404. The power module 412 can use a closed control loop to maintain a preconfigured voltage or current with a tight tolerance at the output. The power module 412 can also protect the rest of the electronics (e.g., hardware processor 420, transceiver 424) from surges generated in the line. In addition, or in the alternative, the power module 412 can be a source of power in itself to provide signals to the other components of the controller 404. For example, the power module 412 can be a battery. As another example, the power module 412 can be a localized photovoltaic power system.

The hardware processor 420 of the controller 404 executes software in accordance with one or more example embodiments. Specifically, the hardware processor 420 can execute software on the control engine 406 or any other portion of the controller 404, as well as software used by the user 450, one or more of the sensors, the master controller 480, and/or one or more of the other electrical devices 402. The hardware processor 420 can be an integrated circuit, a central processing unit, a multi-core processing chip, a multi-chip module including multiple multi-core processing chips, or other hardware processor in one or more example embodiments. The hardware processor 420 is known by other names, including but not limited to a computer processor, a microprocessor, and a multi-core processor.

In one or more example embodiments, the hardware processor 420 executes software instructions stored in memory 422. The memory 422 includes one or more cache memories, main memory, and/or any other suitable type of memory. The memory 422 is discretely located within the controller 404 relative to the hardware processor 420 according to some example embodiments. In certain configurations, the memory 422 can be integrated with the hardware processor 420.

In certain example embodiments, the controller 404 does not include a hardware processor 420. In such a case, the controller 404 can include, as an example, one or more field programmable gate arrays (FPGAs) one or more insulated-gate bipolar transistors (IGBTs), and/or one or more integrated circuits (ICs). Using FPGAs, IGBTs, ICs, and/or other similar devices known in the art allows the controller 404 (or portions thereof) to be programmable and function according to certain logic rules and thresholds without the use of a hardware processor. Alternatively, FPGAs, IGBTs, ICs, and/or similar devices can be used in conjunction with one or more hardware processors 520.

The transceiver 424 of the controller 404 can send and/or receive control and/or communication signals. Specifically, the transceiver 424 can be used to transfer data between the controller 404 and the user 450, the sensor devices 442, the master controller 480, and/or the other electrical devices 402. The transceiver 424 can use wired and/or wireless technology. The transceiver 424 can be configured in such a way that the control and/or communication signals sent and/or received by the transceiver 424 can be received and/or sent by another transceiver that is part of the user 450, the sensors 442, the master controller 480, and/or the other electrical devices 402.

When the transceiver 424 uses wireless technology as the communication link 405, any type of wireless technology can be used by the transceiver 424 in sending and receiving signals. Such wireless technology can include, but is not limited to, Wi-Fi, visible light communication, cellular networking, and Bluetooth. The transceiver 424 can use one or more of any number of suitable communication protocols (e.g., ISA100, HART) when sending and/or receiving signals. Such communication protocols can be dictated by the communication module 408. Further, any transceiver information for the user 450, the sensor devices 442, the master controller 480, and/or the other electrical devices 402 can be stored in the storage repository 430.

Optionally, in one or more example embodiments, the security module 428 secures interactions between the controller 404, the user 450, the master controller 480, and/or the electrical devices 402. More specifically, the security module 428 authenticates communication from software based on security keys verifying the identity of the source of the communication. For example, user software may be associated with a security key enabling the software of the user 450 to interact with the controller 404, the sensor devices 442, the master controller 480, and/or the electrical devices 402. Further, the security module 428 can restrict receipt of information, requests for information, and/or access to information in some example embodiments.

By using example electrical devices 402 (e.g., electrical device 402-1) with camera sensors 441 and in communication with a controller 404 as described herein, the electrical device 402-1 can have the functionality of sensor devices without actually using sensor devices 442. As a result, the electrical device 402-1 can have a more aesthetically appealing look and rely on fewer physical components to perform sensing functions. In addition, because of the versatility of the camera sensor 441, additional parameters can be measured when compared with the limited parameters that more traditional sensor devices 442 are capable of measuring. Based on the information provided by the camera sensor 441, the controller 404 can determine the occurrence of one or more conditions within a space and cause one or more electrical devices 402 (e.g., light fixtures, shade control device, fire control panel, HVAC unit, electrical receptacles) to operate. Further, example embodiments can work “out of the box”, without a user 450 having to input information, adjust settings, or otherwise manipulate the controller 404 before or during installation of an electrical device 402.

One or more of the functions performed by any of the components of an example light fixture (e.g., controller 404) can be performed using a computing device 518. An example of a computing device 518 is shown in FIG. 5. The computing device 518 implements one or more of the various techniques described herein, and which is representative, in whole or in part, of the elements described herein pursuant to certain example embodiments. Computing device 518 is one example of a computing device and is not intended to suggest any limitation as to scope of use or functionality of the computing device and/or its possible architectures. Neither should computing device 518 be interpreted as having any dependency or requirement relating to any one or combination of components illustrated in the example computing device 518.

Computing device 518 includes one or more processors or processing units 514, one or more memory/storage components 515, one or more input/output (I/O) devices 516, and a bus 517 that allows the various components and devices to communicate with one another. Bus 517 represents one or more of any of several types of bus structures, including a memory bus or memory controller, a peripheral bus, an accelerated graphics port, and a processor or local bus using any of a variety of bus architectures. Bus 517 includes wired and/or wireless buses.

Memory/storage component 515 represents one or more computer storage media. Memory/storage component 515 includes volatile media (such as random access memory (RAM)) and/or nonvolatile media (such as read only memory (ROM), flash memory, optical disks, magnetic disks, and so forth). Memory/storage component 515 includes fixed media (e.g., RAM, ROM, a fixed hard drive, etc.) as well as removable media (e.g., a Flash memory drive, a removable hard drive, an optical disk, and so forth).

One or more I/O devices 516 allow a customer, utility, or other user to enter commands and information to computing device 518, and also allow information to be presented to the customer, utility, or other user and/or other components or devices. Examples of input devices include, but are not limited to, a keyboard, a cursor control device (e.g., a mouse), a microphone, and a scanner. Examples of output devices include, but are not limited to, a display device (e.g., a monitor or projector), speakers, a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form at computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 518 is connected to a network (not shown) (e.g., a local area network (LAN), a wide area network (WAN) such as the Internet, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 518 includes at least the minimal processing, input, and/or output means necessary to practice one or more embodiments.

Further, those skilled in the art will appreciate that one or more elements of the aforementioned computer device 518 is located at a remote location and connected to the other elements over a network in certain example embodiments. Further, one or more embodiments is implemented on a distributed system having one or more nodes, where each portion of the implementation (e.g., controller 404) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

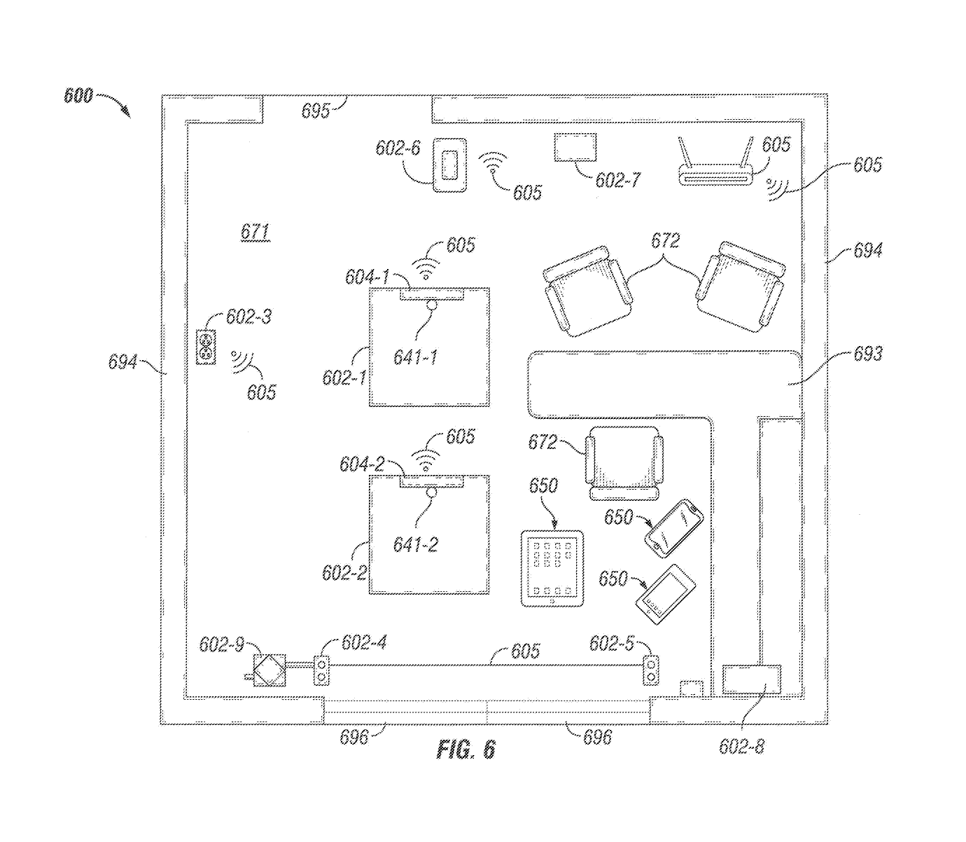

FIG. 6 shows a system diagram of another system 600 that includes a number of electrical devices 602, including some with camera sensors 641 in accordance with certain example embodiments. Specifically, referring to FIGS. 1A-6, the system 600 includes a room (defined by walls 694, a doorway 695, and windows 696) the forms a space 671. In this example, the space 671 is indoors, although example embodiments can be used for spaces that are located outdoors. Within the space 671 are three chairs 672 and a table 693.

Also within the space 671 are a number of electrical devices 602, which include two light fixtures (electrical device 602-1 and electrical device 602-2), three electrical receptacles (electrical device 602-3, electrical device 602-4, and electrical device 602-5), a wall switch (electrical device 602-6), a thermostat (electrical device 602-7) that controls a HVAC unit, a printer (electrical device 602-8), and a shade control device (electrical device 602-9). Electrical device 602-1 includes a local controller 604-1 and a camera sensor 641-1, and electrical device 602-2 includes a local controller 604-2 and a camera sensor 642-2. There are also three devices (e.g., e-pad, PDA, cell phone) associated with a user 650 occupying the space 671.

When the space 671 is not occupied, one or both of the controllers 604 can determine, based on the sensory elements (or lack thereof) captured by the camera sensors 641, that no one is in the space 671. As a result, one or both of the controllers 604 can stop power from flowing to one or more of the electrical receptacles (electrical device 602-3, electrical device 602-4, electrical device 602-5), have the shade control device (electrical device 602-9) close the blinds that cover the windows 696, adjust the setting on the thermostat (electrical device 602-7) to a setting of 78° F., put the printer (electrical device 602-8) in standby mode, and turn off the light sources of the light fixtures (electrical device 602-1 and electrical device 602-2). When someone enters the space 671, one or both of the controllers 604 can determine, based on the sensory elements (e.g., images, sound) captured by the camera sensors 641, that someone is in the space 671. As a result, one or both of the controllers 604 can control the power supplies 438 of the light fixtures to provide a certain amount of power, as well as control color characteristics (e.g., hue, saturation) of the light, so that the light fixtures 602 emit a certain light.

Further, the controller 604-1 and the controller 604-2 of the light fixtures can communicate with each other to control the various electrical devices 602 in the space 671 and/or adjacent to (e.g., in the hallway outside the doorway 695) the space 671. For example, when one or both of the controllers 604 determine, based on the sensory elements captured by the camera sensors 641, that the space 671 is being occupied, the controllers 604 can instruct the shade control device to open the blinds that cover the windows 696. Further, the controllers 604 can adjust the thermostat to a setting of 72° F. In addition, the controllers 604 can allow power to how (as by closing a breaker switch) to the electrical receptacles.

The controllers 604 can also receive and manage the electrical devices of the system 600 based on inputs received from a use 650. For example, if an occupant of the space 671 further adjusts the thermostat (either directly or using a personal device, such as an electronic pad, a PDA, or a cell phone), the controllers 604 can instruct the shade control device to further adjust the blinds that cover the windows 696. As another example, if a utility (e.g., a distribution company, a transmission operator, a generator) sends a demand response signal to reduce the power consumed in the space 671 by 10%, the controllers 604 can reduce the light output by the light fixtures 602 by 10%, shut off the HVAC unit for 2 minutes, send an email to the user 650 about the demand response signal and the resulting actions, and post a message on the display of the thermostat to inform the occupants of the space 671 as to what is occurring and why. If, after the demand response signal has ceased, the one or both controllers 604 of the system 600 of FIG. 6 determine, based on the sensory elements captured by the camera sensors 641, that the space 671 remains occupied, the controllers 604 can control one or more of the electrical devices 602 in the same way that they were controlled by the controllers 604 prior to receiving the demand response signal.

Example embodiments provide a number of benefits. Examples of such benefits include, but are not limited to, little or no set up required; more simplistic installation, replacement, modification, and maintenance of a light fixture; improved aesthetics; improved electrical and operational efficiency; compliance with one or more applicable standards and/or regulations; lower maintenance costs, increased flexibility in system design and implementation; and reduced cost of labor and materials. Example embodiments can be used for installations of new electrical devices (e.g., light fixtures) and/or new sensor devices. Example embodiments can also be integrated (e.g., retrofitted) with existing electrical devices and/or sensor devices.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. An electrical device located in it space, the electrical device comprising:
a functional component for delivering an output;
a camera sensor that captures at least one sensory element, wherein the at least one sensory element indicates at least one condition within the space; and
a controller coupled to the functional component and the camera season, wherein the controller controls the functional component based on the at least one sensory element captured by the camera sensor.

2. The electrical device of claim 1, wherein the controller is disposed within a housing of the electrical device.

3. The electrical device of claim 1, wherein the at least one sensory element comprises an image.

4. The electrical device of claim 3, wherein the at least one condition comprises occupancy within the space.

5. The electrical device of claim 3, wherein the at least one condition comprises directional flow of a person within the space.

6. The electrical device of claim 3, wherein the at least one condition comprises identification of an individual within the space.

7. The electrical device of claim 3, wherein the at least one condition comprises a gesture made by a person in the space.

8. The electrical device of claim 3, wherein the at least one condition comprises a number of people in the space.

9. The electrical device of claim 1, wherein the at least one sensory element comprises an amount of ambient light in the space.

10. The electrical device of claim 1, wherein the at least one sensory element comprises smoke, and wherein the at least one condition comprises a fire.

11. The electrical device of claim 1, wherein the at least one sensory element comprises a sound.

12. The electrical device of claim 1, wherein the functional component comprises a light source, and wherein the output is light.

13. A controller, comprising:
a hardware processor;
memory comprising a plurality of software instructions, wherein the plurality of software instructions are executed by the hardware processor;
a transceiver configured to communicate with a camera sensor; and
a control engine coupled to the transceiver and the hardware processor, wherein the control engine is configured to:
receive a plurality of sensory elements captured by the camera sensor;
determine a condition based on the plurality of sensory elements; and
control at least one electrical device in response to the condition.

14. A system comprising:
a first electrical device located in a space;
a first camera sensor that captures a plurality of sensory elements in the space proximate to the first electrical device; and
a controller coupled to the first electrical device and the first camera sensor, wherein the controller:
receives the plurality of sensory elements captured by the first camera sensor;
determines a condition based on the plurality of sensory elements; and
controls the first electrical device in response to the condition.

15. The system of claim 14, further comprising:
a second electrical device located in the space, wherein the controller further controls the second electrical device in response to the condition.

16. The system of claim 14, wherein the first camera sensor is disposed, at least in part, within a housing of the first electrical device.

17. The system of claim 14, further comprising:
a second camera sensor located in the space, wherein the controller controls the second camera sensor based on the condition.

18. The system of claim 17, wherein the second camera sensor is disposed, at least in part, within a second electrical device.

19. The system of claim 17, wherein the controller communicates with the second camera sensor using wireless technology.

20. The system of claim 14, wherein the space is outdoors.
